(19) United States
(12) Patent Application Publication
(10) Pub. No.: US 2026/0343097 A1
(43) Pub. Date: Oct. 29, 2026

(54) CAMERA MODULE

(71) Applicant: Samsung Electro-Mechanics Co., Ltd., Suwon-si (KR)

(72) Inventors: Bo Sung SEO, Suwon-si (KR); Nam Ju LEE, Suwon-si (KR)

(73) Assignee: Samsung Electro-Mechanics Co., Ltd., Suwon-si (KR)

(21) Appl. No.: 19/640,513

(22) Filed: Apr. 7, 2026

(30) Foreign Application Priority Data
Apr. 29, 2025 (KR) 10-2025-0056659
Jul. 21, 2025 (KR) 10-2025-0097887

(51) Int. Cl. H04N 23/68; H04N 23/54

(52) U.S. Cl. CPC H04N 23/687; H04N 23/54

(57) ABSTRACT

A camera module includes first and second frames; a third frame coupled to a lens barrel, and spaced apart from the first and second frames in an optical axis direction; and a ball member disposed between the third frame and second frames and supporting movement of the third frame in a direction perpendicular to the optical axis relative to the second frame, the third frame includes a first guide groove portion accommodating a portion of the ball member, and the second frame includes a second guide groove portion accommodating another portion of the ball member, H₁+H₂<D is satisfied, where H₁ is a minimum separation distance in the optical axis direction between the first and third frames, H₂ is a maximum separation distance in the optical axis direction between the third and second frames around the first and second guide groove portions, and D is a diameter of the ball member.

### CROSS-REFERENCE TO RELATED APPLICATIONS

This application claims the benefit under 35 USC §119(a) of Korean Patent Application No. 10-2025-0056659 filed on Apr. 29, 2025, and Korean Patent Application No. 10-2025-0097887 filed on Jul. 21, 2025, in the Korean Intellectual Property Office, the entire disclosures of which are incorporated herein by reference for all purposes.

### BACKGROUND

### 1. Field

The following description relates to a camera module.

### 2. Description of Related Art

With a trend toward slimmer mobile devices such as, but not limited to, smartphones, structures of the mobile devices are being proposed to reduce the thickness, or form factor, of camera modules applied thereto.

For example, a direction in which the lens are stacked in the mobile devices may be changed by disposing a reflective member that bends a path of light within the camera module, and a thickness of the camera module may be reduced by eliminating factors that increase the thickness of the camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a first frame and a second frame; a third frame coupled to a lens barrel, and spaced apart from the first frame and the second frame in an optical axis direction; and a ball member disposed between the third frame and the second frame, and configured to support a movement of the third frame in a direction perpendicular to an optical axis relative to the second frame, wherein the third frame comprises a first guide groove portion that accommodates a first portion of the ball member, and the second frame comprises a second guide groove portion that accommodates a second portion of the ball member, and H₁+H₂<D is satisfied, where H₁ is a minimum separation distance in the optical axis direction between the first frame and the third frame, H₂ is a maximum separation distance in the optical axis direction between the third frame and the second frame around the first guide groove portion and the second guide groove portion, and D is a diameter of the ball member.

The ball member may be in contact with the first guide groove portion and the second guide groove portion at one point each.

The first guide groove portion may include a first bottom surface; and a first side wall that extends in the optical axis direction from an edge of the first bottom surface, wherein the second guide groove portion includes a second bottom surface that faces the first bottom surface in the optical axis direction; and a second side wall that extends in the optical axis direction from an edge of the second bottom surface, and wherein the ball member is in contact with the first bottom surface and the second bottom surface.

The maximum separation distance (H₂) in the optical axis direction between the third frame and the second frame around the first guide groove portion and the second guide groove portion may be a maximum distance between the portions of the first side wall and the second side wall facing each other in the optical axis direction.

The first frame may be coupled to the second frame, and a portion of the first frame and a portion of the second frame may oppose each other in the optical axis direction, with respect to the third frame.

A protrusion may be disposed on the first frame to penetrate the first frame in the optical axis direction, and wherein one side of the protrusion may face to the third frame in the optical axis direction.

The minimum separation distance (H₁) in the optical axis direction between the first frame and the third frame may be a distance between the one side of the protrusion and the third frame in the optical axis direction.

The first frame may include a cover portion that is spaced apart from the third frame in the optical axis direction; and an extension portion that extends from the cover portion in the optical axis direction, and is coupled to the second frame, wherein the protrusion is disposed in the cover portion.

The first guide groove portion and the second guide groove portion may have a width that is greater than the diameter (D) of the ball member.

The first guide groove portion and the second guide groove portion may satisfy the following conditional expression: W₂<W₁, where W₁ is a width of the first guide groove portion, and W₂ is a width of the second guide groove portion.

A magnet may be disposed on the third frame, wherein a yoke may be disposed on the second frame, and the yoke faces the magnet in the optical axis direction, and wherein the third frame may be supported by the second frame in the optical axis direction by an attractive force that is generated by the magnet and the yoke.

A coil may face the magnet in the direction perpendicular to the optical axis, wherein the third frame may be configured to move in the direction perpendicular to the optical axis based on a driving force that is generated by the magnet and the coil.

The first frame, the second frame and the third frame may be accommodated in a housing, and the first frame, the second frame and the third frame may be configured to move in the optical axis direction relative to the housing.

In a general aspect, a camera module includes a housing; a first moving portion disposed in the housing and configured to move in an optical axis direction; a second moving portion disposed in the housing and configured to move in the optical axis direction and in a direction perpendicular to an optical axis; and a ball member disposed between surfaces of the first moving portion and the second moving portion that face each other in the optical axis direction, wherein a maximum distance in the optical axis direction between the first moving portion and the second moving portion adjacent to the ball member is less than a diameter of the ball member.

The first moving portion may include a first frame that is disposed on a first side of the second moving portion in the optical axis direction; and a second frame that is disposed on a second side of the second moving portion in the optical axis direction; wherein the second moving portion is disposed to be spaced apart from the first frame and the second frame in the optical axis direction.

The first moving portion and the second moving portion may each include a guide groove portion that accommodates the ball member, and the guide grooves may have a width that is greater than the diameter of the ball member.

The guide groove portion that is disposed in the second moving portion may have a width that is greater than a width of the guide groove portion that is disposed in the first moving portion.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a partially exploded perspective view of the example camera module, in accordance with one or more embodiments.

FIG. 3 illustrates a perspective view of a fixed portion and a movable portion of an example camera module, in accordance with one or more embodiments.

FIG. 4A illustrates a cross-sectional view taken along line I-I’ of FIG. 1.

FIG. 4B illustrates a cross-sectional view taken along line II-II’ of FIG. 1.

FIG. 5 illustrates a plan view of an example camera module, in accordance with one or more embodiments.

FIGS. 6, 7 and 8 are enlarged views of a guide groove portion (region A) in which the second ball member of FIG. 4A is accommodated.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” "connected to," "coupled to," or "joined to" another component, element, or layer, it may be directly (e.g., in contact with the other component, element, or layer) “on,” "connected to," "coupled to," or "joined to" the other component element, or layer, or there may reasonably be one or more other components elements, or layers intervening therebetween. When a component or element is described as "directly on", "directly connected to," "directly coupled to," or "directly joined to" another component element, or layer, there can be no other components, elements, or layers intervening therebetween. Likewise, expressions, for example, "between" and "immediately between" and "adjacent to" and "immediately adjacent to" may also be construed as described in the foregoing.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C", and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module having a slim thickness, and which minimizes risks that may occur in a slim structure.

One or more examples may provide the miniaturization and slimming of the camera module, and prevent the detachment of ball members disposed in the camera module.

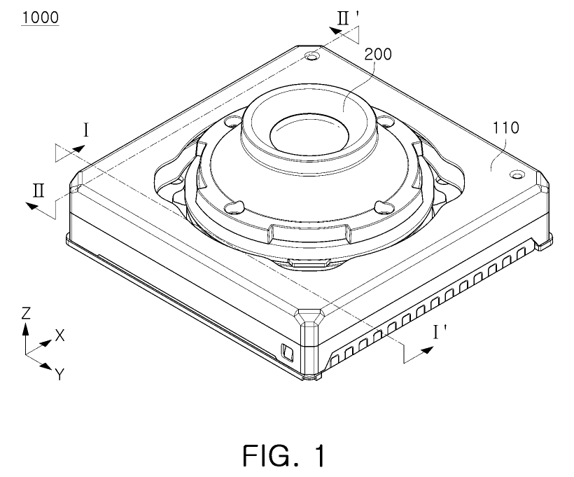

FIG. 1 illustrates a perspective view of an example camera module, in accordance with one or more embodiments.

An example camera module 1000 illustrated in FIG. 1 may be mounted on a mobile device such as, but not limited to, a smartphone. The optical axis of the camera module 1000 is formed parallel to a Z-axis direction of FIG. 1, and the camera module 1000 may be mounted on the mobile device so that its optical axis corresponds to a thickness direction of the mobile device.

The camera module 1000, in accordance with one or more embodiments, may be manufactured to have a slim thickness in the optical axis direction. According to an embodiment, the camera module 1000 may have a structure in which a ball member which guides the movement of a lens to compensate for shaking, may roll in multiple directions. Furthermore, to prepare for problems that may arise from such changes, surrounding structures may be constructed to satisfy specific condition(s).

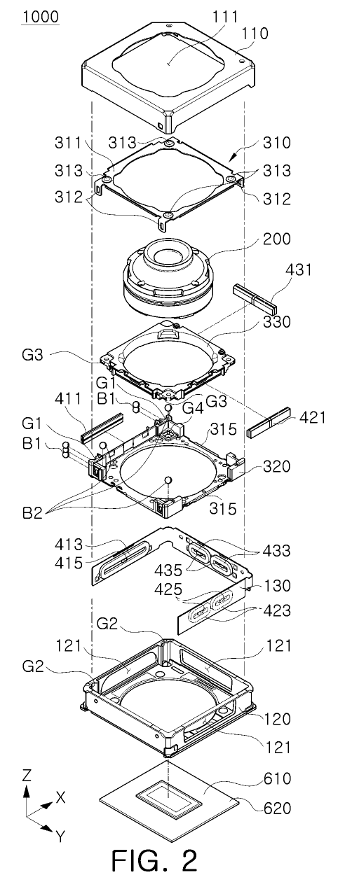

FIG. 2 illustrates a partially exploded perspective view of an example camera module, in accordance with one or more embodiments.

A camera module 1000, in accordance with one or more embodiments, may be configured roughly as illustrated in FIG. 2.

Light reflected from an external object is refracted as it passes through plurality of lenses and is formed into an image on an image sensor 610. The plurality of lenses and the image sensor 610 are aligned in the optical axis direction, and the direction in which incident light propagates within the camera module 1000 does not change.

The plurality of lenses and the image sensor 610 are disposed in a housing 120. In an example, a plurality of lenses are mounted on a lens barrel 200 and accommodated in an internal space of the housing 120, and an image sensor 610 is mounted on a printed circuit board 620 and coupled to a bottom surface of the housing 120. The housing 120 may have an open shape in the optical axis direction, so that incident light may pass through the lens barrel 200 and enter the image sensor 610.

A case 110 may be combined with the housing 120 to cover the internal space.

An opening portion 111 may be formed in the case 110 so that light reflected from an external subject may enter the camera module 1000. The lens barrel 200 is disposed in the opening portion 111, so that light reflected from an external subject may enter the lens barrel 200.

Additionally, a printed circuit board 130 equipped with a coil and the like may be disposed in the housing 120.

The printed circuit board 130 may be disposed on the side surface(s) of the housing from outside of the housing 120. A through-hole 121 is provided on the side surface(s) of the housing 120, and the printed circuit board 130 may be disposed in the housing 120 such that a surface on which the coil and the like is attached faces the internal space of the housing 120.

In an example, the camera module 1000 may have an autofocus (AF) adjustment operation and a shake correction (optical image stabilization (OIS)) operation, and both of these operations may be implemented by moving the lens barrel 200. For example, when the autofocusing operation is performed, the lens barrel 200 may be configured to move in the optical axis direction, and when the shake correction operation is performed, the lens barrel 200 may be configured to move in a direction perpendicular to the optical axis.

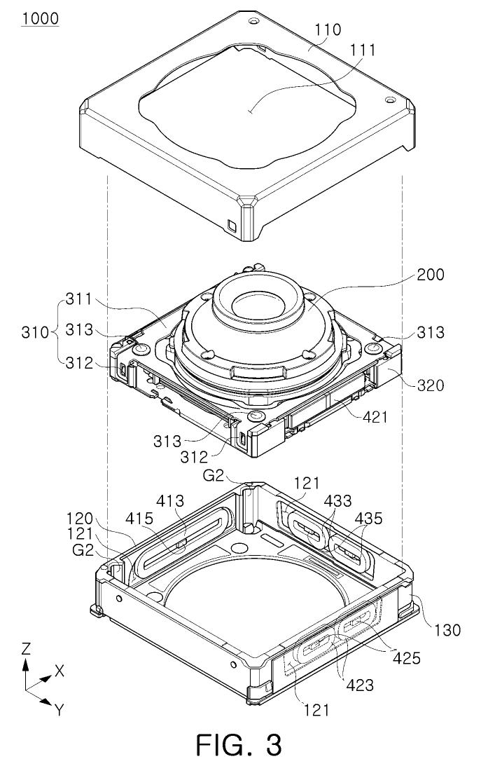

FIG. 3 illustrates a perspective view of a fixed portion and a movable portion of a camera module, in accordance with one or more embodiments.

The internal space of the housing 120 may accommodate a plurality of frames moving together with the lens barrel 200. According to an embodiment, a first frame 310, a second frame 320, and a third frame 330 may be accommodated in the internal space of the housing 120. The lens barrel 200 may be coupled to the third frame 330.

The first frame 310, the second frame 320, and the third frame 330 may be provided to be movable in the internal space of the housing 120 in the optical axis direction. That is, during autofocusing adjustment, the first frame 310, the second frame 320, and the third frame 330 may all be moving bodies that move relative to the housing 120. Additionally, the third frame 330 may be provided to be more movable in the direction perpendicular to the optical axis. This may be a relative movement with respect to the first frame 310 and the second frame 320. That is, during shake correction, the third frame 330 may be a moving body, while the first frame 310 and the second frame 320 may be fixed bodies.

The camera module 1000, in accordance with one or more embodiments, may include an actuator (hereinafter, first actuator) that generates a driving force in the optical axis direction.

The first actuator may include a first magnet 411 and a first coil 413. The first magnet 411 may be disposed on one side surface of the second frame 320, and the first coil 413 may be disposed on one side surface of the housing 120 facing one side surface of the second frame 320 where the first magnet 411 is disposed.

In an embodiment, the first coil 413 may be attached to the printed circuit board 130 disposed on the side surface(s) of the housing 120. The through-hole 121 is formed on the side surface of the housing 120, and the first coil 413 is disposed in the through-hole 121 so as to directly face the first magnet 411.

The first magnet 411 and the first coil 413 are disposed to face each other in a direction perpendicular to the optical axis so as to generate the driving force in the optical axis direction.

In an example, a first position sensor 415 may be disposed together with the first coil 413 on the printed circuit board 130, and the optical axis direction disposed of the lens barrel 200 may be detected through the first position sensor 415. In an example, the first position sensor 415 may be a Hall sensor.

A ball member (hereinafter, first ball member) B1, that guides a movement of the second frame 320 in the optical axis direction, may be disposed between the second frame 320 and the housing 120.

The first ball member B1 may include a plurality of ball members. The first ball member B1 may be divided into two groups, each consisting of one or more ball members and disposed on both sides in the longitudinal direction of the first magnet 411.

The guide groove portions G1 and G2 in which the first ball member B1 is received may be formed in the second frame 320 and the housing 120. The guide groove portions G1 and G2 are formed to extend in the optical axis direction, and the first ball member B1 may roll along the guide groove portions G1 and G2 in the optical axis direction while being accommodated in the guide groove portions G1 and G2.

The second frame 320 may be supported on the housing 120 with the first ball member B1 disposed therebetween. In an embodiment, a yoke (not illustrated) may be disposed in the housing 120 to face the first magnet 411 with the first ball member B1 interposed therebetween. The yoke and the first magnet 411 may generate a force in a direction facing each other, for example, a direction perpendicular to the optical axis, and the second frame 320 may be pressed against the housing 120 by the force.

In an example, as described above, when adjusting the focus of the camera module 1000, the first frame 310 and the third frame 330 may also move in the optical axis direction together with the second frame 320.

According to an embodiment, the third frame 330 may be accommodated inside the second frame 320, and a ball member (hereinafter, a second ball member) B2 may be disposed between the second frame 320 and the third frame 330. Since the third frame 330 may be supported on the second frame 320 through the second ball member B2, the third frame 330 may move in the optical axis direction along with the second frame 320 when the second frame 320 moves in the optical axis direction. Likewise, the lens barrel 200 coupled to the third frame 330 may also move in the optical axis direction.

The first frame 310 may be coupled to the second frame 320 so that the first frame 310 may move in the optical axis direction along with the second frame 320, and the like. The first frame 310 may be coupled to the second frame 320 to cover the third frame 330 accommodated on the inside of the second frame 320. For example, the first frame 310 may include a cover portion that covers the third frame 330 and a leg portion coupled (attached) to the second frame 320.

The camera module 1000, in accordance with one or more embodiments, may include an actuator (hereinafter, second actuator) that generates a driving force in a direction perpendicular to the optical axis.

The second actuator may include a second magnet 421 and a second coil 423, a third magnet 431 and a third coil 433.

The second magnet 421 and the third magnet 431 may be disposed on two side surfaces of the third frame 330. In an example, the second magnet 421 and the third magnet 431 may be disposed perpendicular to each other. The second coil 423 and the third coil 43) may be disposed on two side surfaces of the housing 120 facing the two side surfaces of the third frame 330, and may be disposed perpendicular to each other.

The second coil 423 and the third coil 433 may be attached to the printed circuit board 130 like the first coil 413. The second coil 423 and the third coil 433 may directly face the second magnet 421 and the third magnet 431, respectively, through the through-hole 121 formed in the housing 120.

The second magnet 421 and the second coil 423, and the third magnet 431 and the third coil 433 may be respectively disposed to face each other in the direction perpendicular to the optical axis, and may generate driving force in the direction facing each other.

In accordance with one or more embodiments, the ball member that guides a movement during shake correction is configured to roll in multiple directions, so that unintended rotation may occur during the shake correction process. Accordingly, the second actuator may have a configuration that generates a rotational force.

In an example, the second magnet 421 and the third magnet 431 may include one or more magnets, and the second coil 423 and/or the third coil 433 may include multiple coils. At least one of the second coil 423 and the third coil 433 may control the driving force by including a plurality of independently controllable coils.

The second actuator may compensate for unintended rotation by controlling the driving force generated by the second magnet 421 and the second coil 423 and/or the driving force generated by the third magnet 431 and the third coil 433. Alternatively, similarly, rotational force may be intentionally generated by varying the driving force, or by utilizing the resultant force of the driving force.

A second position sensor 425 and a third position sensor 435 may be provided on the printed circuit board 130. The second position sensor 425 may be attached to the same surface as the second coil 423, and the third position sensor 435 may be disposed on the same surface as the third coil 433. According to an embodiment, at least one of the second position sensor 425 and the third position sensor 435 may be provided in multiple numbers to detect a rotation of the lens barrel 200. In an example, the second position sensor 425 and the third position sensor 435 may be Hall sensors.

As described above, the second ball member B2 may be disposed between the third frame 330 and the second frame 320.

The second ball member B2 may include a plurality of ball members. In a non-limited example, the second ball member B2 may be provided in three or four pieces, and each piece may be spaced apart from each other to be disposed at each corner portion of the third frame 330 and the second frame 320.

The second ball member B2 may have an operation of guiding the movement of the third frame 330 and maintaining a gap between the third frame 330 and the second frame 320.

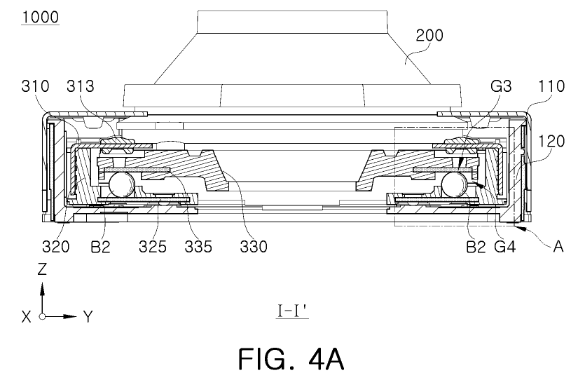

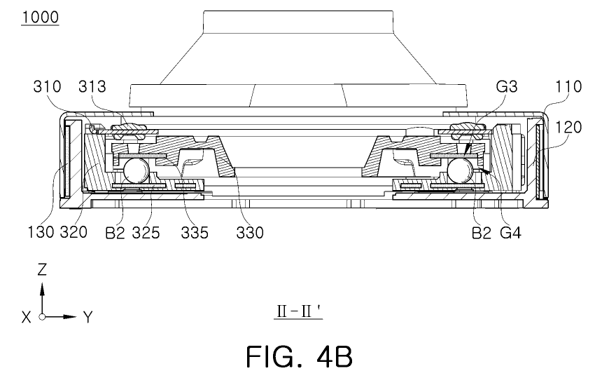

FIG. 4A is a cross-sectional view taken along line I-I’ of FIGS. 1 and 4B is a cross-sectional view taken along line II-II’ of FIG. 1.

The guide groove portions G3 and G4 that receive the second ball member B2 may be formed on the surfaces facing each other in the optical axis direction of the third frame 330 and the second frame 320. For example, a first guide groove portion G3 may be formed in the third frame 330, and a second guide groove portion G4 may be formed in the second frame 320 to face the first guide groove portion G3. The second ball member B2 may be disposed between the first guide groove portion G3 and a second guide groove portion G4. The first guide groove portion G3 may accommodate a portion of the second ball member B2, and the second guide groove portion G4 may accommodate another portion of the second ball member B2.

The first guide groove portion G3 and the second guide groove portion G4 may be provided in a number corresponding to the number of ball members of the second ball member B2. Therefore, one ball member may be disposed between the first guide groove portion G3 and the second guide groove portion G4 facing each other.

The first guide groove portion G3 and the second guide groove portion G4 may have a polygonal or circular shape when viewed from the optical axis direction. Additionally, the sizes of the first guide groove portion G3 and the second guide groove portion G4 may be greater than a diameter of the second ball member B2. For example, the cross-sections of the first guide groove portion G3 and the second guide groove portion G4 cut in a direction perpendicular to the optical axis are greater than the diameter of the second ball member B2, and the specific shapes of the first guide groove portion G3 and the second guide groove portion G4 are not limited as long as the sizes of the cross-sections are greater than the diameter of the second ball member B2.

The second ball member B2 may move in a rolling motion in a direction of the driving force generated by the second actuator while being disposed between the first guide groove portion G3 and the second guide groove portion G4. The second ball member B2 may roll in a direction perpendicular to the optical axis and may roll freely on a plane perpendicular to the optical axis.

The first guide groove portion G3 may include a bottom surface (hereinafter, the first bottom surface) 331, and the second guide groove portion G4 may include a bottom surface (hereinafter, the second bottom surface) 321 facing the first bottom surface 331 in the optical axis direction. The first bottom surface 331 and the second bottom surface 321 may be approximately perpendicular to the optical axis and may also be approximately parallel to each other. For example, the cross sections of the first guide groove portion G3 and the second guide groove portion G4 described above may be the first bottom surface 331 and the second bottom surface 321.

Additionally, the first guide groove portion G3 may include a first side wall 332 extending in the optical axis direction from the edge of the first bottom surface 331. Similarly, the second guide groove portion G4 may also include a second side wall 322 extending in the optical axis direction from the edge of the second bottom surface 321.

The second ball member B2 may contact the first bottom surface 331 and the second bottom surface 321, respectively. That is, the second ball member B2 may make one-point contact with the first guide groove portion G3 on the first bottom surface 331 and one-point contact with the second guide groove portion G4 on the second bottom surface 321. Additionally, the second ball member B2 may be spaced apart from, or in contact with, the first side wall 332 and the second side wall 322 depending on the position changing as it rolls.

In an embodiment, the second frame 320 and the third frame 330 may include reinforcing plates 325 and 335. The reinforcing plates 325 and 335 are provided for the purpose of supplementing the rigidity of the second frame 320 and the third frame 330, and therefore may be formed of a material having superior rigidity to the main material of the second frame 320 and the third frame 330. In a non-limiting example, the reinforcing plates 325 and 335 may be stainless steel material.

The reinforcing plates 325 and 335 may be manufactured integrally with the second frame 320 and the third frame 330 by insert injection, and may form a portion of the second frame 320 and the third frame 330.

The reinforcing plates 325 and 335 may be disposed internal of the second frame 320 and the third frame 330 so that a portion of them are exposed to the external. For example, the reinforcing plates 325 and 335 may be exposed to the external through the first bottom surface 331 of the first guide groove portion G3 in which the second ball member B2 is received and the second bottom surface 321 of the second guide groove portion G4. Accordingly, the second ball member B2 may roll while in contact with the reinforcing plates 325 and 335.

The third frame 330 may be supported on the second frame 320 with the second ball member B2 interposed therebetween. In an embodiment, a yoke 315 may be disposed on the second frame 320 to face the second magnet 421 and the third magnet 431 with the second ball member B2 interposed therebetween. The yoke 315 may be provided in two pieces so that it may face the second magnet 421 and the third magnet 431, respectively. The yoke 315 generates an attractive force in the direction facing the second magnet 421 and the third magnet 431, for example, in the optical axis direction, and the third frame 330 may be pressed against the second frame 320 by the attractive force.

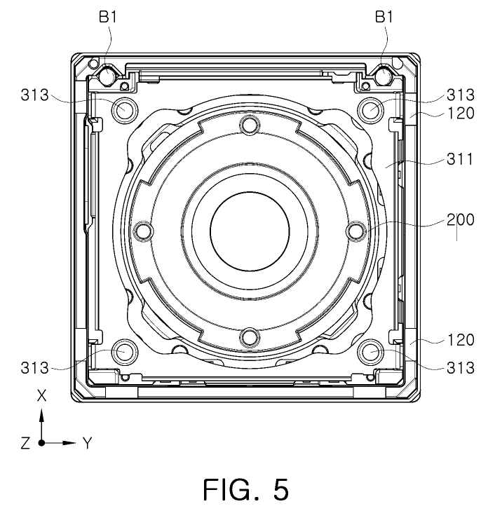

FIG. 5 illustrates a plan view of a camera module, in accordance with one or more embodiments.

FIG. 5 illustrates an example in which the case 110 may be removed from the camera module 1000, and the first frame 310 may be disposed at the bottom of the case 110.

The second frame 320 may be open in the optical axis direction, and the first frame 310 may be coupled to the second frame 320 so as to cover the open portion of the second frame 320. Since the third frame 330 may be disposed in the open portion of the second frame 320, the third frame 330 may also be covered by the first frame 310.

That is, the first frame 310 to the third frame 330 may overlap in the optical axis direction at least in a portion, and in the overlapping portion, they may be disposed in the order of the first frame 310, the third frame 330, and the second frame 320.

The first frame 310 may include a cover portion 311 that covers the third frame 330 and the like, and an extension portion 312 that is bent in the optical axis direction from the cover portion 311.

The first frame 310 may be coupled to the second frame 320 through the extension portion 312. For example, the extension portion 312 may be coupled to the side surface of the second frame 320.

The first frame 310 may include a protrusion 313 that protrudes in the optical axis direction from the cover portion 311.

In an example, the first frame 310 may include a plurality of protrusions 313. At least a portion of the plurality of protrusions 313 may be provided at positions corresponding to the second ball member B2. That is, the protrusion 313 may overlap with the second ball member B2 in the optical axis direction.

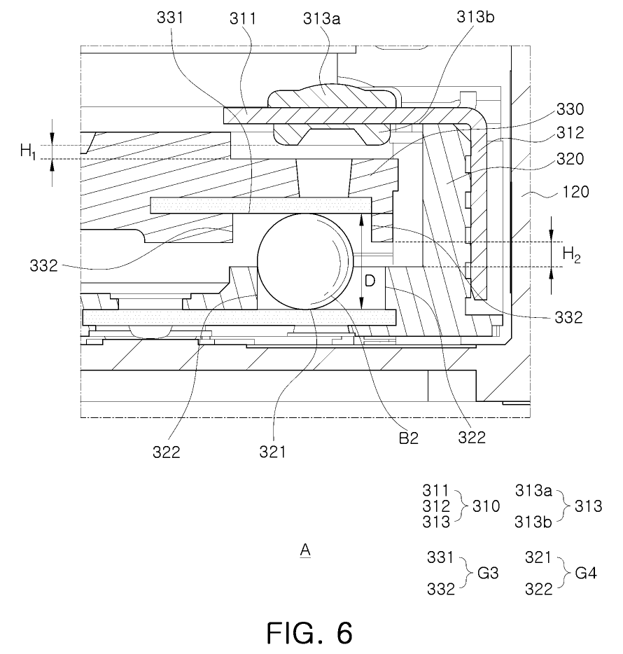

One side of the protrusion 313 may protrude from one surface of the cover portion 311 in a direction toward the case 110, and the other side of the protrusion 313 may protrude from the other surface of the cover portion 311 in a direction toward the third frame 330. Accordingly, referring to FIG. 6, one side 313a of the protrusion may face the case 110 in the optical axis direction, and the other side 313b of the protrusion 313 may face the third frame 330 in the optical axis direction.

The protrusion 313 may have the operation of alleviating shock and noise and regulating the range of movement.

Since the first frame 310 is coupled to the second frame 320, the first frame 310 may move in both directions in the optical axis direction together with the second frame 320. In an embodiment, when the second frame 320 moves in the optical axis direction away from the image sensor 610, the protrusion 313 may gradually approach the case 110 and may come into contact (collide) with the case 110 at one side 313a of the protrusion. In an example, the other side 313b of the protrusion may come into contact (collide) with the third frame 330 when an external impact occurs.

The protrusion 313 may be formed of a material such as an elastic polymer (e.g., polyurethane), rubber, silicone, and the like. The protrusion 313 of this material may effectively absorb shock and noise by elastically deforming its shape when in contact (collision) with the case 110.

In an example, the second ball member B2 and the peripheral parts of the second ball member B2 may be implemented to satisfy the following conditions.

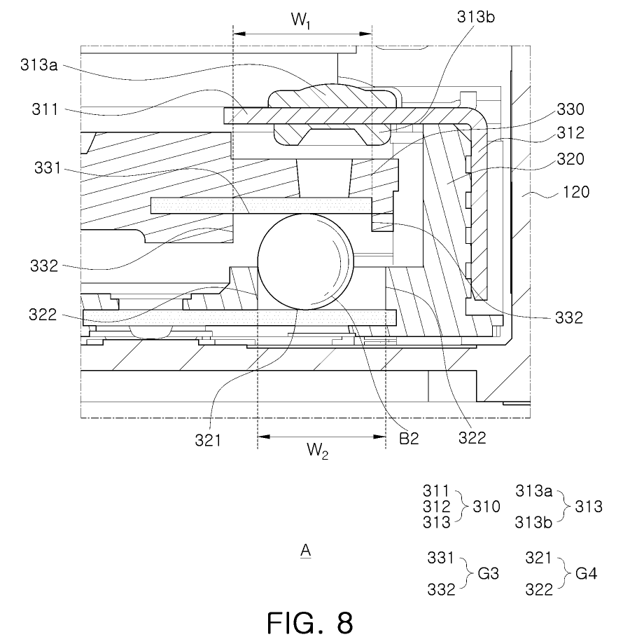

FIGS. 6-8 are enlarged views of the guide groove portion (region A) in which the second ball member of FIG. 4A is accommodated. For reference, FIGS. 6-8 are enlarged views of region A, but the implementation conditions described below may be equally applied to the remaining regions where the second ball member B2 is accommodated.

The camera module 1000 may satisfy the following conditional expression at the corner portion where the second ball member B2 is disposed.

H₁+H₂<D

In the conditional expression, H₁ is a minimum separation distance formed between the first frame 310 and the third frame 330 in the optical axis direction, H₂ is a maximum separation distance formed between the third frame 330 and the second frame 320 around the first guide groove portion G3 of the third frame 330 and the second guide groove portion G4 of the second frame 320, in the optical axis direction, and D is a diameter of the second ball member B2.

The minimum separation distance H₁ formed between the first frame 310 and the third frame 330 in the optical axis direction may be the optical axis direction distance from the protrusion 313 of the first frame 310 to the third frame 330. More specifically, it may be a distance in the optical axis direction between the other side 313b of the protrusion facing the third frame 330 in the optical axis direction and one surface (upper surface based on the drawing) of the third frame 330.

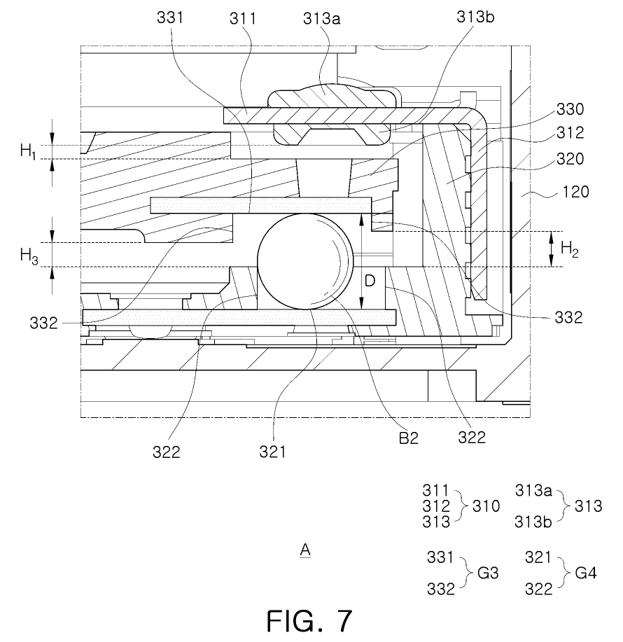

The maximum separation distance H₂ formed in the optical axis direction between the first guide groove portion G3 of the third frame 330 and the second guide groove portion G4 of the second frame 320 may be the maximum distance between the portions of the first guide groove portion G3 and the second guide groove portion G4 facing each other in the optical axis direction. More specifically, it may be the maximum distance between the portions facing the optical axis of the first side wall 332 and the second side wall 322 (in FIG. 7, H₃<H₂)

According to the conditional expression, a sum of the minimum separation distance H₁ formed between the first frame 310 and the third frame 330 in the optical axis direction, and the sum of the maximum separation distance H₂ formed between the first guide groove portion G3 of the third frame 330 and the second guide groove portion G4 of the second frame 320 in the optical axis direction may be less than a diameter D of the second ball member B2.

The third frame 330 may be supported by the second frame 320 magnetically via the second ball member B2, but is not structurally restrained, so the third frame 330 may be momentarily separated from the second ball member B2 and the second frame 320 due to an external impact, and the like. In this example, the second ball member B2 inserted between the first guide groove portion G3 and the second guide groove portion G4 may be detached externally.

The sum of the minimum separation distance H₁ formed between the first frame 310 and the third frame 330 in the optical axis direction and the maximum separation distance H₂ formed between the first guide groove portion G3 of the third frame 330 and the second guide groove portion G4 of the second frame 320 in the optical axis direction, corresponds to the maximum distance formed when the third frame 330 is separated from the second frame 320 in the optical axis direction.

Additionally, the camera module (1000) can additionally satisfy the following condition:

W₂<W₁

In the conditional expression, W1 is a width of the first guide groove portion G3, and W2 is a width of the second guide groove portion G4.

The width W1 of the first guide groove portion G3 is a distance between the first side walls 332 facing each other with the second ball member B2 therebetween, and the width W2 of the second guide groove portion G4 is a distance between the second side walls 322 facing each other with the second ball member B2 therebetween.

According to the condition, the width W1 of the first guide groove portion G3 may be greater than the width W2 of the second guide groove portion G4.

The second ball member B2 is accommodated in the first guide groove portion G3 and the second guide groove portion G4 to guide movement of the third frame 330 relative to the second frame 320 in a direction perpendicular to the optical axis. In particular, the second ball member B2 may reduce friction due to a movement in the direction perpendicular to the optical axis by performing rolling motion in the direction perpendicular to the optical axis within the first guide groove portion G3 and the second guide groove portion G4.

The first guide groove portion G3 and the second guide groove portion G4 may be formed to have sufficient space (width) to allow the second ball member B2 to roll smoothly. In particular, since the amount of movement of the second ball member B2 is less than the amount of movement of the third frame 330, if the first guide groove portion G3 does not have sufficient space (width), a driving load may increase due to the slip phenomenon of the second ball member B2. However, if the first guide groove portion G3 has a wider width than the second guide groove portion G4 as in the embodiment, and thus the rolling movement space of the second ball member B2 is sufficiently secured, the slip phenomenon may be prevented and the driving stability may be increased.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a first frame and a second frame;
a third frame coupled to a lens barrel, and spaced apart from the first frame and the second frame in an optical axis direction; and
a ball member disposed between the third frame and the second frame, and configured to support a movement of the third frame in a direction perpendicular to an optical axis relative to the second frame,
wherein the third frame comprises a first guide groove portion that accommodates a first portion of the ball member, and the second frame comprises a second guide groove portion that accommodates a second portion of the ball member, and
H₁+H₂<D is satisfied,
where H₁ is a minimum separation distance in the optical axis direction between the first frame and the third frame, H₂ is a maximum separation distance in the optical axis direction between the third frame and the second frame around the first guide groove portion and the second guide groove portion, and D is a diameter of the ball member.

2. The camera module of claim 1, wherein the ball member is in contact with the first guide groove portion and the second guide groove portion at one point each.

3. The camera module of claim 1, wherein the first guide groove portion includes a first bottom surface; and a first side wall that extends in the optical axis direction from an edge of the first bottom surface,
wherein the second guide groove portion includes a second bottom surface that faces the first bottom surface in the optical axis direction; and a second side wall that extends in the optical axis direction from an edge of the second bottom surface, and
wherein the ball member is in contact with the first bottom surface and the second bottom surface.

4. The camera module of claim 3, wherein the maximum separation distance (H₂) in the optical axis direction between the third frame and the second frame around the first guide groove portion and the second guide groove portion is a maximum distance between the portions of the first side wall and the second side wall facing each other in the optical axis direction.

5. The camera module of claim 1, wherein the first frame is coupled to the second frame, and
wherein a portion of the first frame and a portion of the second frame oppose each other in the optical axis direction, with respect to the third frame.

6. The camera module of claim 1, wherein a protrusion is disposed on the first frame to penetrate the first frame in the optical axis direction, and
wherein one side of the protrusion faces to the third frame in the optical axis direction.

7. The camera module of claim 6, wherein the minimum separation distance (H₁) in the optical axis direction between the first frame and the third frame is a distance between the one side of the protrusion and the third frame in the optical axis direction.

8. The camera module of claim 6, wherein the first frame comprises:
a cover portion that is spaced apart from the third frame in the optical axis direction; and
an extension portion that extends from the cover portion in the optical axis direction, and is coupled to the second frame,
wherein the protrusion is disposed in the cover portion.

9. The camera module of claim 1, wherein the first guide groove portion and the second guide groove portion each have a width that is greater than the diameter (D) of the ball member.

10. The camera module of claim 9, wherein the first guide groove portion and the second guide groove portion satisfy the following conditional expression:
W₂<W₁
where W₁ is a width of the first guide groove portion, and W₂ is a width of the second guide groove portion.

11. The camera module of claim 1, wherein a magnet is disposed on the third frame,
wherein a yoke is disposed on the second frame, and the yoke faces the magnet in the optical axis direction, and
wherein the third frame is supported by the second frame in the optical axis direction by an attractive force that is generated by the magnet and the yoke.

12. The camera module of claim 11, wherein a coil faces the magnet in the direction perpendicular to the optical axis,
wherein the third frame is configured to move in the direction perpendicular to the optical axis based on a driving force that is generated by the magnet and the coil.

13. The camera module of claim 1, wherein the first frame, the second frame and the third frame are accommodated in a housing, and
wherein the first frame, the second frame and the third frame are configured to move in the optical axis direction relative to the housing.

14. A camera module, comprising:
a housing;
a first moving portion disposed in the housing and configured to move in an optical axis direction;
a second moving portion disposed in the housing and configured to move in the optical axis direction and in a direction perpendicular to an optical axis; and
a ball member disposed between surfaces of the first moving portion and the second moving portion that face each other in the optical axis direction,
wherein a maximum distance in the optical axis direction between the first moving portion and the second moving portion adjacent to the ball member is less than a diameter of the ball member.

15. The camera module of claim 14, wherein the first moving portion comprises a first frame that is disposed on a first side of the second moving portion in the optical axis direction; and a second frame that is disposed on a second side of the second moving portion in the optical axis direction;
wherein the second moving portion is disposed to be spaced apart from the first frame and the second frame in the optical axis direction.

16. The camera module of claim 14, wherein the first moving portion and the second moving portion each comprises a guide groove portion that accommodates the ball member, and
wherein the guide grooves have a width that is greater than the diameter of the ball member.

17. The camera module of claim 16, wherein the guide groove portion that is disposed in the second moving portion has a width that is greater than a width of the guide groove portion that is disposed in the first moving portion.
